(19) United States
(12) Patent Application Publication
(10) Pub. No.: US 2026/0119796 A1
(43) Pub. Date: Apr. 30, 2026

(54) SUMMARIZATION SERVICE SYSTEM OF ENGLISH ISSUE ARTICLE USING WEB CRAWLER AND LLM

(71) Applicant: MIRAE CIT, Inc., Seoul (KR)

(72) Inventors: Wontae KIM, Seoul (KR); Dongkwon KIM, Seoul (KR)

(73) Assignee: MIRAE CIT, Inc., Seoul (KR)

(21) Appl. No.: 19/036,575

(22) Filed: Jan. 24, 2025

(30) Foreign Application Priority Data
Oct. 30, 2024 (KR) 10-2024-0151631

(51) Int. Cl. G06F 40/284; G06F 16/951; G06F 40/166

(52) U.S. Cl. CPC G06F 40/284; G06F 16/951; G06F 40/166

(57) ABSTRACT

A summarization service system for English issue articles using a web crawler and an LLM include a web crawler system that crawls English issue articles from overseas media, stores news lists and articles classified by category, and provides a user with a keyword search for issue articles; and an LLM article summarization system that performs input embedding on only at least one sentence containing a keyword of an issue article selected by text mining into an LLM model, performs text embedding (token embedding) and position encoding by the LLM model to store numeric vectors of the selected sentences of the issue article and position information thereof in a vector database, performs sentence classification (SC) on the selected sentences of the issue article, and then provides a summary of the issue article.

### CROSS-REFERENCE TO RELATED APPLICATION

This application claims priority to Korean Patent Application No. 10-2024-0151631, filed on Oct. 30, 2024, the disclosures of which is herein incorporated by reference in its entirety.

This invention was supported by a grant of Institutes for Information & Communication Technology Planning & evaluation of Ministry of Science and ICT (IITP, No. 2022-0-00302, Development of global demand forecasting and analysis/prediction system of market/industry trends.

### BACKGROUND OF THE INVENTION

### Field

The present disclosure relates to a summarization service system for overseas English issue articles using a web crawler and a large language model (LLM).

### Description of Related Art

Natural Language Processing (NLP) is a technology that allows a computer to understand the syntactic/semantic nature of human language through a natural language analysis. A language model (LM) is a model processed by a computer by assigning probabilities to sentences (word sequences) or words based on a training data dataset.

As prior art 1, Korean Patent Publication No. 10-2023-0047849 discloses “METHOD AND SYSTEM FOR SUMMARIZING DOCUMENT USING HYPERSCALE LANGUAGE MODEL.”

For example, if a word is w and a word sequence is an uppercase letter W, the probability of a word sequence W in which n words appear is expressed as P(W)=P(w₁, w₂, w₃, w₄, w₅, . . . , wₙ).

The probability of a next word appearing, when n−1 words are listed, a conditional probability of an n-th word is expressed by the following equation.

$$P ( {w}_{n} \vert {w}_{1} , … {w}_{n - 1} )$$

For example, the probability of a fourth word is expressed as follows:

$$P ( {w}_{4} \vert {w}_{1} , {w}_{2} , {w}_{3} )$$

The probability of an entire word sequence W is known after all words have been predicted, and the probability of a word sequence is expressed as follows:

$$P ( W ) = P ( {w}_{1} , {w}_{2} , {w}_{3} , {w}_{4} , {w}_{5} , … , {w}_{n} ) = {\prod }_{i = 1}^{n} P ( {w}_{i} \vert {w}_{1 , … ,} {w}_{i - 1} )$$

FIG. 1 is an encoder/decoder architecture of a transformer for a large language model (LLM).

An encoder block of Google's transformer in 2017 consists of, subsequent to text input embedding, positional encoding, multi-head attention, residual connection & layer normalization, a feed forward neural network (FFN) including an input layer, a hidden layer, and an output layer. A decoder block includes the elements of the encoder block and further includes masked multi-head attention.

Text embedding converts human languages into computer languages, converts sentences into numeric vectors, and stores them in a vector database along with positional information, which is also called input embedding or token embedding.

Tokenizers create vocabulary dictionaries based on the statistics of words, and parse text into tokens.

TABLE 1

| token | token-id | Description |
|---|---|---|
| <pad> | 0 | A short sentence is padded with <pad> to match |
| | | a length of a long sentence to handle sentences |
| | | of different lengths |
| <unk> | 1 | When a tokenizer encounters an unknown word, a |
| | | token for treating it as unknown |
| <s> | 2 | A token that indicates a beginning of a sentence, |
| | | a begin of sentence (BOS), a classification |
| | | (CLS) token |
| </s> | 3 | A token that indicates an end of a sentence, an |
| | | end of sentence (EOS), a separator (SEP) token |
| <mask> | 4 | A token used in training a masked language model |
| | | (MLM), used to solve a problem of matching a |
| | | token by masking the token |

Positional encoding creates a vector that distinguishes positional information and adds a vector that distinguishes positional information to the input text embedding to provide an encoder input. Dropout randomly drops out some tokens by replacing them with 0 probabilistically to prevent overfitting during a training process of a deep learning model, and excludes them from model training in the calculation.

Multi-head attention has an architecture that derives associations with tokens from multiple heads, respectively, and the feed forward neural network (FFN) synthesizes the multi-head attention results point-wise in units of tokens and outputs the results to a next transformer layer. Self attention performed in both the encoder and decoder performs a weighted sum of an input vector sequence Xi, which is input embedded, and multiplies each weight through matrix multiplication and adds the multiplied values to convert the input vector sequence Xi into a query Q, a key K, and a value V.

$$Q = Xi \times {W}_{Q}$$

$$K = Xi \times {W}_{K}$$

$$V = Xi \times {W}_{V}$$

$$Mltihead ( Q , K , V ) - Concat ( {head}_{1} , … {head}_{h} ) {W}^{Q}$$

$${wherehead}_{1} = Attention ( {QW}_{i}^{Q} , {KW}_{i}^{K} , {VW}_{i}^{V} )$$

where the projections are parameter metrices.

$${W}_{i}^{Q} ∈ \text{?} , {W}_{i}^{K} ∈ \text{?} , {W}_{i}^{V} ∈ \text{?} , and {W}_{i}^{O} ∈ \text{?}$$

$$\text{?} \text{indicates text missing or illegible when filed}$$

Here, Q is a query, K is a key, V is a value, W is a weight, K^{T} is a matrix that transposes all key vectors, dₖ is a key dimension.

Self attention using vector, in which both the encoder and decoder of the transformer are executed, calculates three vectors for each word, which are the query Q, the key K, and the value V, from input numeric vectors embedded in text input to the encoder.

After the query Q and the key K are matrix-multiplied, all the element values of the matrix are divided by a square root of the key dimension dₖ, softmax (Xi) is executed on the matrix in units of rows to generate a score matrix, and the score matrix is matrix-multiplied by the value V to complete the calculation of self attention. </s>, which indicates an end of a sentence, is learned by attaching it to an end of a sentence in a target language.

$$softmax ( {X}_{i} ) = \frac{exp ( {X}_{i} )}{{\sum }_{j} exp ( {X}_{i} )}$$

Multi-head attention outputs a sequence of vectors corresponding to the input words.

Residual connection is calculated as F(x)+x when an input is x and a target block is F.

Layer normalization performs normalization by subtracting a mean of x, E(x), and dividing by a standard deviation \sqrt{v[x]}. β and γ are weights that are updated during a training process, and ε is a fixed value of 1e-5 that is added to prevent a denominator from becoming 0.

$$y = \frac{x - E ( x )}{\sqrt{V ( x ) - ε}} γ + β$$

The encoder and decoder of the transformer are repeated N times for multi-head attention, residual connection, and layer normalization respectively.

Then, a linear process and a softmax function are executed.

In order to prevent overfitting during a training process of a deep learning model, some of neurons are dropped out and replaced with 0 probabilistically to exclude them from calculation.

A feed forward neural network (FFN) consists of an input layer, a hidden layer, and an output layer. Add a bias b to a result of adding a neuron value Xi and its weight Wi. An activation function f of a feed forward neural network (FFN) used in the transformer uses a rectified linear unit (ReLU). In a neural network calculation process, if an activation function f(x)=max(0, x), then

$$f ( {\sum }_{j} {w}_{i} {x}_{i} + b )$$

is output.

Google has released a bidirectional encoder representation from transformers (BERT) and Gemini, which are based on an encoder of a transformer, to provide pre-training and fine tuning on a large corpus stored in a database consisting of sentences/words that do not contain labels so as to be used in natural language processing (NLP). A BERT language model provides pre-training and fine tuning on a large corpus, wherein BERT, which is a pre-training method, executes pre-training by using a large language model that learns a large corpus by an upstream task that learns widely through a transformer, and then executes transfer learning.

Also, Open AI has developed Chat-GPT and GPT-40, which utilize generative AI techniques based on a decoder of a transformer, to provide language translation, database search, and question answering, conversational chatbot services.

Open AI's generative pre-trained transformer (GPT) language model is a natural language processing (NLP) large language model (LLM) based on the transformer's decoder, and ChatGPT provides language translation, text generation, and question answering services based on pre-trained data.

In the field of NLP, a process of converting natural language into numeric vectors that can be understood by computers is called embedding, and embedding provides the following three functions.
1) Calculation of relevance between words/sentences
2) Implication of semantic/grammatical information between words (word analogy assessment)
3) Transfer learning (using good embeddings as input values for deep learning models)

Referring to FIG. 2, BERT is a transfer learning method that trains a pre-trained language model using large unlabeled data such as Wikipedia (2.5 billion words) and BooksCorpus (800 million words) and adds a neural network for a specific task (document classification, question answering, translation, etc.) based thereon.

The BERT language model basically provides a model that has been pre-trained on a large amount of word embeddings, and thus sufficiently executes various natural language processing tasks with relatively few resources. BERT's input representation consists of a sum of three embedding values as shown in the diagram.

When a number of encoder layers of the transformer is L, a size of d_model is D, and a number of self attention heads is A, respective sizes are as follows.

$$BERT - Base : L = 12 , D = 768 , A = 12 : 110 M parameters$$

$$BERT - Large : L = 24 , D = 1024 , A = 16 : 340 M parameters$$

The input of the BERT model is embedding vectors. If d_model is set to 768, then all words are input as 768-dimensional embedding vectors and used as an input to BERT. Subsequent to performing internal operations, BERT model outputs 768-dimensional vectors for each word.

Tokenization is first performed for input into the transformer-based natural language processing models of BERT and GPT. A GPT tokenizer uses byte pair encoding (BPE), but a BERT tokenizer uses a WordPiece tokenizer, which is a sub-word tokenizer that is smaller than a word. The sub-word tokenizer basically adds a frequently appearing word to a word set as it is, but for a rare word, it is separated into smaller units called sub-words and the sub-words are added to the word set.

Tokenization uses word-level tokenization, character-level tokenization, and sub-word level tokenization for sentences.

### 1) Token Embeddings

Token embeddings use an encoder of a transformer, use a self attention model, and use a word piece embedding method. A frequently appearing word (sub-word) becomes a single unit in itself, and a rare word is split into smaller sub-words. The BERT language model uses [CLS] and [September] tokens (classification tokens) at the beginning and end of each input sentence, respectively, and the [CLS] token has a combined meaning of a token sequence after passing through all layers of the model. Here, a simple classifier may be added to classify it as a single sentence or a series of sentences.

### 2) Segment Embeddings

Segment embeddings reconstruct words divided into tokens into a single sentence, and generate masks with values of 0s up to a first [September] token and 1s up to a subsequent [September] token to distinguish respective sentences.

### 3) Position Embeddings

Position embeddings encode the order of tokens, and self attention uses position encodings using a sigmoid function in a transformer to provide position information of input tokens. Three respective embeddings are added for each token and used as an input vector for BERT.

Natural language processing using BERT is carried out in two stages, wherein the encoder of the transformer performs pre-training and fine-tuning to train input sentences through text embeddings and execute a natural language processing task.

PyTorch is used as a deep learning framework, and an Adam optimizer is used to minimize errors.

Referring to FIG. 3, a GPT architecture is shown.

Open AI's GPT (Generative pre-trained transformer), which is a language model that generates output values by utilizing an attention principle introduced by Open AI in 2018, is a large language model (LLM) that uses a decoder of a generative pre-trained transformer.

The GPT model is pre-trained with a large unlabeled text dataset, and attention uses a deep learning mechanism that measures associations between each word in an input value of a sentence input to the GPT model, calculates a degree of attention based on the relationship, and generates an output value to generate characters.

The GPT architecture utilizes a transformer architecture that uses an attention mechanism, which largely consists of four layers: an input embedding layer, an attention layer, a feed forward layer, and an output embedding layer.

First, text embedding is a step of converting human languages into computer languages, and is also called input embedding or token embedding.

Second, position embedding is carried out. The order of words is very important in human languages. The architecture of the transformer has an architecture in which input values are input in parallel at once rather than sequentially, wherein the transformer-based GPT performs a process of adding position information to understand the order of words, which is called position embedding. Position embedding is widely used with sinusoidal positional embedding using sin and cos functions, which have shown the best learning performance up to now.

Third, dropout randomly drops out some tokens by replacing them with 0 probabilistically to prevent overfitting during a training process of a deep learning model, and excludes them from model training in the calculation.

Data that has passed through three steps is input into a next layer, a self attention layer.

A masked multi-head self attention layer is a layer that learns associations (relationships) between each data. An attention weight having the order of all words (numeric vectors) and associations between each word is assigned. In the self attention layer, associations between each word are identified, and an attention score required to generate an output value is calculated.

Calculate scores→process masking→apply softmax function→calculate attention scores

An input value is classified into three values, such as a query, a key, and a value, through matrix multiplication.

Describing a process of calculating an attention score, a query Q of a single word is multiplied by keys K of all words (K). That is, an i-th query Qᵢ is multiplied once with each key from first to last n-th keys K₁ to Kₙ. This value is called a score, and is expressed by a formula such as g*k^{T} (T: transpose matrix).

Then, the score is masked, and the GPT model learns unidirectionally through calculation with a masking matrix called an attention mask, and calculates the masked score. That is, GPT model is a uni-directional model that predicts a next word through previous words, and when learning an i-th word, it does not include words subsequent to the i-th word in the learning.

For the score that has passed through the masking process, a probability value is calculated using the softmax function, and associations between each word (numeric vector) is identified through the probability value.

Then, the value V of each word is multiplied and added (summed) together to calculate a final weight, and this value is called an attention score. That is, a process of mathematically calculating relationships between words (number vectors) and generating weights called attention scores is performed in the self attention layer.

In reality, it is an architecture in which multiple attention layers are respectively trained in parallel using a multi-head, and the query Q, the key K, and the value V are calculated separately for each attention head. Each attention head is trained independently, and attention scores are calculated for each head, thereby allowing the GPT model to perform more complex learning.

The masked multi-head self attention layer calculates an attention score required for output value inference through the above processes, and the equation is expressed as follows.

$$Attention ( Q , K , V ) = softmax ( \frac{{QK}^{T}}{\sqrt{{d}_{k}}} ) V$$

Here, Q is a query, K is a key, V is a value, W is a weight, K^{T} is a matrix that transposes all key vectors, dₖ is a key dimension.

QK^{T}: A score that is a matrix product of a query Q and a key K.

Softmax: A process of randomizing masked scores.

Softmax*V: A final attention score that is a matrix product of a randomized value and a value V.

In an Add & Norm process, “Add” is a process of adding an input value (x) that has not passed through the layer to an output value (F(x)) that has passed through the layer. Here, the value x is bypassed through skip connection without passing through the layer. Skip connection allows a network to access information in previous layers by allowing data to bypass intermediate layers, reducing various risks, such as gradient vanishing, that tend to occur as a neural network becomes deeper.

Layer normalization adjusts word (numeric vector) information to normalized values.

Subsequent to passing through the self attention layer and the add and norm normalization processes, the output value is input to a next layer, the feed forward layer (FFN). The FFN has a multi-layer perceptron (MLP) architecture, and is a fully-connected layer in which neurons in all layers of the input layer, the hidden layer, and the output layer are fully connected layer without any disconnection.

The FFN of the GPT model consists of two MLP layers, in which a first MLP layer allows input values to be learned as high-dimensional patterns with complex data representations, allowing the GPT model to learn more complex, high-dimensional patterns. Then, the data is passed through an activation function and returned to its original dimensions through a second MLP layer.

When using a ReLU function as the activation function, the activation function outputs data with a (−) weight as 0, and data with a (+) weight as its value to achieve efficient learning by considering the weight of the data. The GPT model uses a GeLU activation function, which models complex functions better than other types of activation functions.

The GPT model repeats self attention and feed forward layers N times across multiple layers. GPT models perform tasks such as text summarization, data extraction from documents, and question answering and the like.

The data provided from the FFN layer passes through the Add & Norm process again, and then executes an output embedding & softmax process.

Output embedding executes embedding to simplify the data that has passed through the multilayer neural network and express it as a probability value, and the data is converted into non-normalized probabilities (logit values) through output embedding, and those values are provided as input values to the softmax function. The larger a logit value, the higher a probability.

The logit values are converted into ‘normalized probability values’ using the softmax function. The softmax function is a function that randomizes weights such that a sum of all input values becomes 1.

Representative methods for determining a next word based on probability values include a greedy decoding method which determines a value with a highest probability as a next word, and a beam search method which predicts a next word by considering a number of cases for n values with high probability. The latter has higher accuracy than the former, but is slower in calculation speed.

A final output value (word) through determination is once again input into an input side of the model to predict the next word so as to execute learning and inference.

The GPT model generates a resulting text by repeating the above process.

However, the existing system have not provided a summarization service for issue articles while web crawling overseas media issue articles that affect overseas markets and the global value chain (GVC) of the economy.

### CITATION LIST

(Patent Document 1) Korean Patent Publication No. 10-2023-0047849 (Publication Date: Apr. 10, 2023), “METHOD AND SYSTEM FOR SUMMARIZING DOCUMENT USING HYPERSCALE LANGUAGE MODEL”, Naver Corporation

### SUMMARY OF THE INVENTION

To solve the above problems, an aspect of the present disclosure is to provide a summarization service system for overseas English issue articles using a web crawler and LLM, which performs web crawling on English issue articles from overseas media, classifies a news list by category, stores a news article list and article data in a server DB, then sets keywords for items of interest in issue articles, searches for issue articles using keywords, selects sentences containing keywords in issue articles using text mining, deletes sentences that do not contain keywords in issue articles, and provides a summary of issue articles using an LLM model of natural language processing (NLP).

In order to achieve the above objectives, a summarization service system for English issue articles using a web crawler and LLM, the summarization service system may include a web crawler system that crawls English issue articles from overseas media, stores news lists and articles classified by category, and provides a keyword search for issue articles; and an LLM article summarization system that performs input embedding on only at least one sentence containing a keyword of an issue article selected by text mining into an LLM model, performs text embedding (token embedding) and position encoding by the LLM model to store numeric vectors of the selected sentences of the issue article and position information thereof in a vector database, sentence classification (SC) on the selected sentences of the issue article, and then provides a summary of the issue article.

A summarization service system for English issue articles using a web crawler and LLM in the present disclosure crawls English issue articles from overseas media, classifies news by category, stores article lists/articles in a server DB, then performs sentence classification (SC) on issue articles for each article list/article, then selects sentences containing a keyword of issue articles by text mining from sentences (sentences 1, 2, 3, 4, etc.) constructing issue articles, deletes sentences that do not contain the keyword of the issue articles based on a relevance to the keyword of the issue articles by natural language inference (NLI), performs NLP processing by performing text embedding and position encoding only on sentences that contain one or more sentences (sentence 2) selected by an LLM model (BERT or GPT-4), and provides a summary of issue articles from overseas media.

An overseas media issue article summarization service provides a summary of English issue articles, and provides market and economic outlook for issues to companies and customers who need to predict and preemptively respond to risks in the global value chain (GVC) so as to become a very useful solution for economic organizations and companies that need to make decisions.

### BRIEF DESCRIPTION OF THE DRAWINGS

FIG. 1 is an encoder/decoder architecture of a transformer for an LLM.

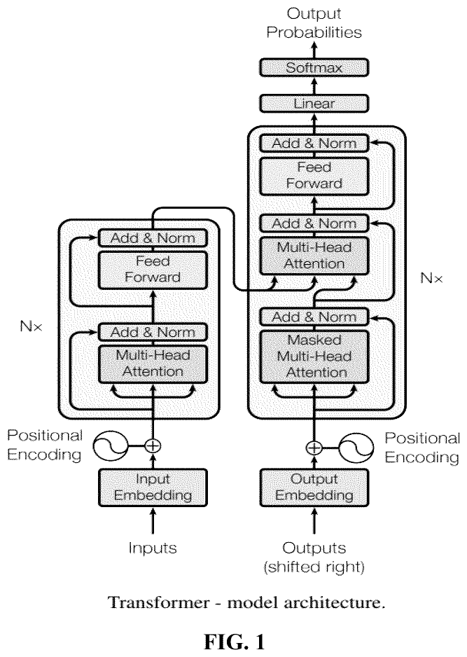

FIG. 2 shows a BERT architecture.

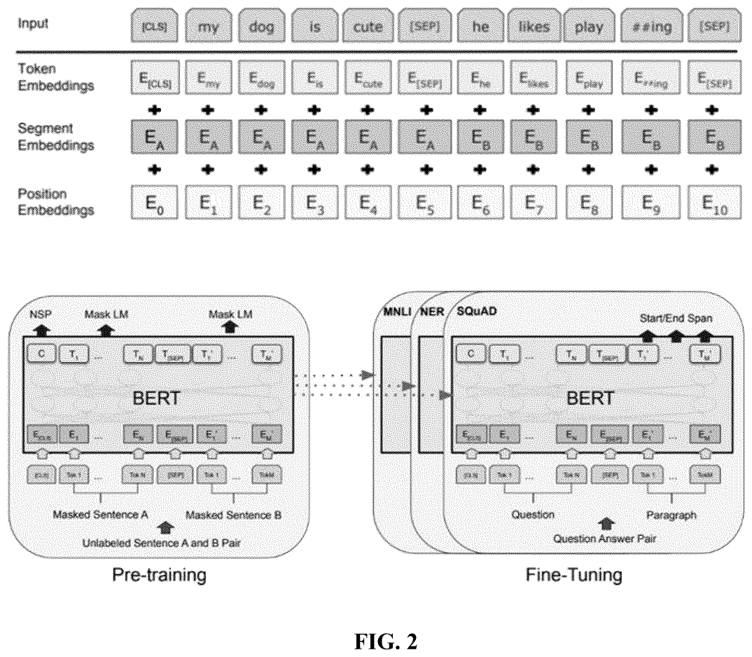

FIG. 3 shows an architecture of a crawling module of a web crawler system.

FIG. 4 is a diagram showing a data processing process of a summarization service system for English issue articles using a web crawler and LLM according to the present disclosure.

FIG. 5 is a flowchart showing a method of summarizing overseas English issue articles using a web crawler and LLM according to the present disclosure.

### DETAILED DESCRIPTION OF THE INVENTION

Hereinafter, the configuration and operation of preferred embodiments of the present disclosure will be described in detail with reference to the accompanying drawings.

The present disclosure may not be limited to the disclosed embodiments and implemented in various different forms by those skilled in the art. In describing the present disclosure, a detailed description thereof will be omitted when it is determined that a specific description publicly known technologies or configurations related thereto may unnecessarily obscure the subject matter of the present disclosure. Additionally, in the accompanying drawings, reference numbers are given to the same reference numbers in other drawings when indicating the same element.

However, it should be understood that the present disclosure is not limited to specific embodiments, but includes all modifications, equivalents, or substitutes included in the concept and technical scope of the present disclosure.

A summarization service system for English issue articles using a web crawler and LLM provides a summarization service for issue articles from overseas media such as CNN USA, NYT (New York Times), WSJ (Wall Street Journal), Reuters UK, and the like that affect the global value chain (GVC) in the event of disasters such as the Ukraine-Russia war, the U.S. Federal Reserve's interest rate hike, coronavirus (COVID-19), super typhoons, earthquakes, and electric vehicle battery explosions.

A summarization service system for English issue articles using a web crawler and LLM crawls English issue articles from overseas media, classifies news by category, stores article lists/articles in a server DB, then performs sentence classification (SC) on issue articles for each article list/article, then selects a sentence (sentence 2) containing a keyword of issue articles by text mining from sentences (sentences 1, 2, 3, 4, etc.) constructing issue articles, deletes sentences (sentences 1, 3, and 4) that do not contain the keyword of the issue articles based on a relevance to the keyword of the issue articles by natural language inference (NLI), performs NLP processing by performing text embedding and position encoding only on sentences that contain at least one sentence (sentence 2) selected by an LLM model (BERT or GPT-4). The LLM model uses a BERT model or a GPT-4 model. The LLM model uses tokens of selected sentences as input embeddings to distinguish the beginnings and the ends of the sentences, extracts words from the selected sentences, uses/deletes phrases/clauses as they are based on whether a relevance between a numeric vector of each word included in noun phrases/adjective phrases/adverb phrases or noun clauses/adjective clauses/adverb clauses and a numeric vector of a keyword of an issue article is above/below a specific value, and provides a summary of issue articles from overseas media that affect the global value chain (GVC).

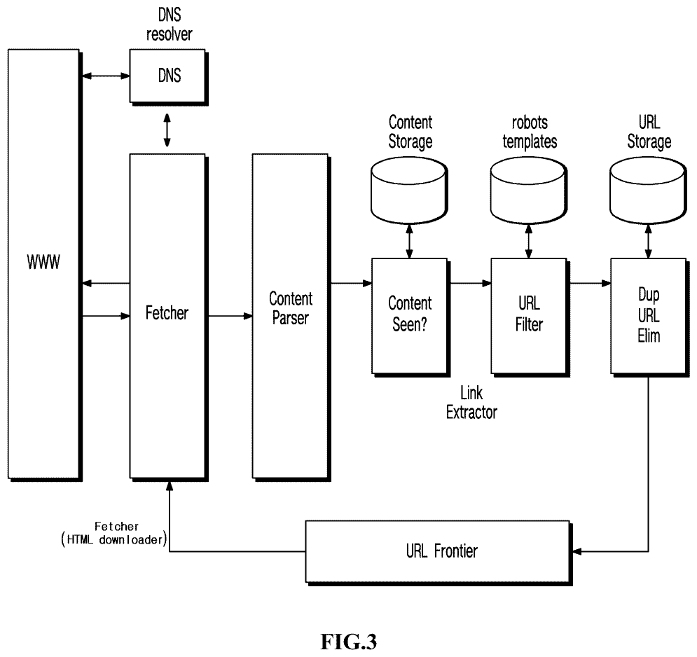

FIG. 3 shows an architecture of a crawling module of a web crawler system.

The web crawler system 10 may include:
a web server and a database;
an issue article data collection unit that collects English issue articles from authorized overseas media and stores the collected articles in a DB, or a crawling module that crawls English issue articles of the overseas media to classify news issue articles by category, and stores article lists/articles in a server DB of the web crawler system; and
a keyword search module that searches for English issue articles of the overseas media, and performs a search using keywords in the issue articles.

The summarization service system for overseas English issue articles using a web crawler and LLM sets keywords (wars, epidemics, typhoons, earthquakes, electric car battery explosions, etc.) in areas of interest for issue articles that occur in the global value chain (GVC) and disasters such as wars, epidemics (COVID-19), typhoons, earthquakes, and electric vehicle battery explosions, and provides a user with a keyword search for issue articles using keywords in the areas of interest for the preset issue articles.

The web crawler system 10 uses a Python crawling program or Selenium automated program and API including a fetcher and a content parser and a URL frontier, which are provided with an HTML downloader made with a web crawler to search/download article websites and store them in a content storage (database).

Crawling collects content on a website using an automated program, downloads HTML pages to store them in a content storage, parses HTML/CSS, and extracts only necessary data from the visited URL.

In an embodiment, the crawling module created a crawler by writing a script in Python, and utilized Open API for a service that provides Rest API to extract only necessary data from issue article data.

Additionally, a technique of programming a browser such as Selenium to extract only the necessary data may be used.

A web crawler uses a Python crawling program or an automated program such as Selenium and an API to search/download websites and store them in a content storage (database). The web crawler is a program that automatically downloads HTML data on a website screen to store the downloaded data in the content storage.

The web crawler manages its crawling status with (1) a URL to download, and (2) a downloaded URL. In particular, web pages should not be collected and stored indiscriminately, and there are html pages that can be collected by the rules written in robot.txt, and html pages that cannot be collected and are prohibited from unauthorized redistribution in accordance with the copyright of overseas media articles. For reference, Google defines robots.txt as a file that instructs search engine crawlers which pages or files they can or cannot request from a site. The file defines the paths that the crawler can request or that it should not crawl. In addition, how many seconds intervals to send requests may be limited in robots.txt.

Upon receipt of seed URLs to start crawling, the web crawler first finds related URLs by a URL frontier, finds another hyperlink from the URLs, and when the URL frontier first passes a URL to be explored to a fetcher, which has an HTML downloader, the fetcher downloads the HTML content of the webpage by means of the HTML downloader, stores the downloaded HTML content in the content storage, passes it to a content parser, and continuously finds other hyperlinks. The contents parser parses the downloaded html web page.

For example, upon receipt of a seed URL to start crawling, the web crawler finds related URLs, finds other another hyperlink from those URLs, and continues to repeat this process by means of a DNS resolver (domain name converter), and downloads the HTMLs of the hyperlinks through an HTML downloader and stores the downloaded HTMLs in a content storage. The HTML downloader downloads a web page from the Internet. In this case, in order for the HTML downloader to download a web page and store the downloaded web page in a URL storage, the DNS resolver converts a URL into an IP address, and the HTML downloader uses the DNS resolver to find out the IP address corresponding to the URL, downloads a web page, checks “Content Seen?” whether it is the ‘body content’ of a page that has already been visited, and stores it in the content storage, and then checks “URL Seen?” whether it is the URL that has already been visited, and since visiting the URL that has already been visited at this time will cause an infinite loop, the URL filter removes the URLs that have already been visited and duplicate URLs and passes them back to the URL frontier to continuously search and repeat this process.

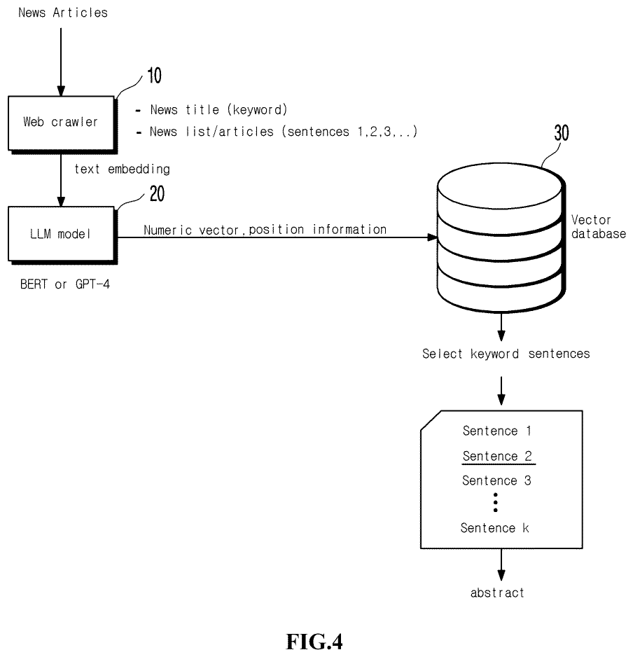

FIG. 4 is a diagram showing a data processing process of a summarization service system for English issue articles using a web crawler and LLM according to the present disclosure.

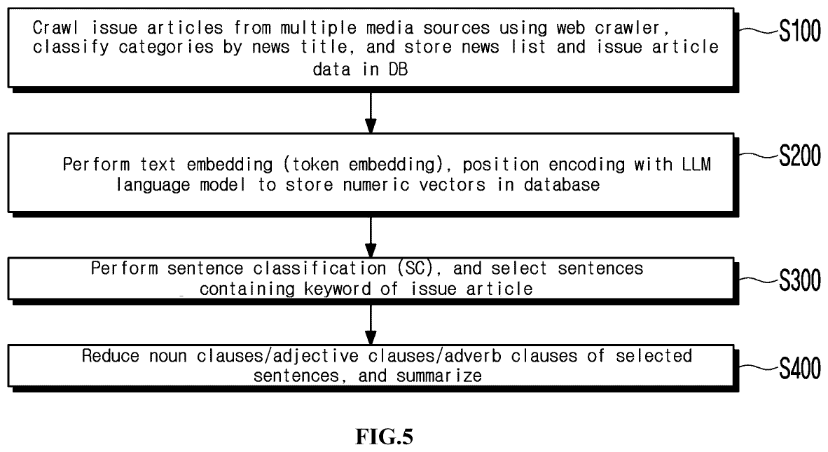

FIG. 5 is a flowchart showing a method of summarizing overseas English issue articles using a web crawler and LLM according to the present disclosure.

A summarization service system for overseas English issue articles using a web crawler and LLM includes:
an issue article data collection unit that collects English issue articles from authorized overseas media and stores the collected articles in a DB, or a web crawler system 10 that crawls English issue articles from overseas media, stores news lists and articles classified by category in a database, and provides a keyword search for issue articles; and
an LLM issue article summarization system that sets keywords in areas of interest for the English issue articles, provides a keyword search function for the issue articles, selects at least one sentence containing the keyword of the issue article by text mining from sentences (sentences 1, 2, 3, 4, etc.) that construct the issue article, deletes sentences that do not contain the keyword of the issue article, and performs input embedding on only at least one sentence containing the keyword of the issue article into an LLM model 20, wherein the LLM model 20 performs text embedding, token embedding, and position embedding on the issue article based on pre-training to store the characters of the issue article as numeric vectors and position information thereof in a vector database 30, performs sentence classification (SC) on selected sentences of an issue article, then selects/deletes noun phrases/adjective phrases/adverb phrases and/or noun clauses/adjective clauses/adverb clauses based on a relevance of each word extracted from the selected sentences containing the keyword of the issue article and the keyword, and provides a summary of issue articles from overseas media using a keyword combination algorithm based on English grammar, sentence format, and word order.

The summarization service system English issue articles using a web crawler and LLM further includes a user terminal that collects and crawls English issue articles from overseas media and stores the collected articles in a database (DB), sets keywords for issue articles and searches the keywords, and displays a summary of the issue articles of the overseas media, and
the user terminal uses a computer, laptop computer, or smartphone/tablet PC.

In an embodiment, sentences (sentence 1, 2, 3, 4, . . . ) that construct an issue article are recognized in “units of words”. The summarization service for issue articles may delete long sentences with no keywords in the issue article and omit phrases/paragraphs.

A summarization service system for overseas English issue articles using a web crawler and LLM is configured to:
delete, for sentences (sentences 1, 2, 3, and 4) that make up the issue articles, a sentence (sentence 2) that contains the keyword of the issue article is selected by the text mining, and sentences (sentences 1, 3, and 4) that do not contain the keyword of the issue article;
apply only the selected sentence (sentence 2) containing the keyword of the issue article to the LLM model 20, and convert words constructing the selected sentence into numeric vectors by text embedding and position encoding to execute an NLP processing of the LLM model; and
the LLM model provides a summary of the issue article using only the sentences containing the keywords of the issue article using a BERT model or GPT-4 model.

The LLM article summarization system includes:
an issue article storage module connected to the crawling module to crawl issue articles of the overseas media, classify the news issue articles by category, and store an article list/articles in a server DB;
a vector database that stores numeric vectors that have passed by text embedding (token embedding)/position encoding on sentences of the English issue articles and position information thereof;
a keyword search module that searches for English issue articles from overseas media, sets and stores the keyword in areas of interest for the English issue articles, and provides a keyword search for the issue articles; and
an issue article summarization module using an LLM that selects, by a server, a sentence (sentence 2) containing a keyword for English issue articles from overseas media, deletes the remaining sentences (sentences 1, 3, and 4) that do not contain the keyword of the issue article, performs sentence classification (SC, sentence set) on selected sentences by text embedding with the LLM model, then classifies sentences by distinguishing the beginnings and ends of the selected sentences, calculates a distance and similarity between two vectors by using a cosine similarity between a numeric vector of each word extracted from the selected sentence (sentence 2) and a numeric vector of the keyword of the issue article, calculates a relevance, which is a similarity greater than a specific value, uses noun phrases/adjective phrases/adverb phrases or noun clauses/adjective clauses/adverb clauses of the selected sentence (sentence 2) greater than a relevance having a similarity above a specific value between the keyword of the issue article and words that construct the selected sentence as they are, deletes noun phrases/adjective phrases/adverb phrases or noun clauses/adjective clauses/adverb clauses less than the relevance, generates and stores a summary of the issue article using a keyword combination algorithm of words/phrases/clauses that construct the selected sentence in accordance with English grammar, sentence format, and word order, and provides a summary of the issue article to the user terminal.

Similarly, the issue article summary module using the LLM uses noun phrases/adjective phrases/adverb phrases of the selected sentence (sentence 2) higher than a relevance having a similarity greater than a specific value as they are, and deletes noun phrases/adjective phrases/adverb phrases less than the relevance (dropout).

In order to reduce an amount of LLM calculation subsequent to performing sentence classification (SC, sentence set) on English issue articles, the LLM article summarization system uses text data mining of a simple database up to a process of first selecting sentences containing the keyword of the issue article from a set of sentences of English issue articles from overseas media, and the selected sentences—sentences containing the keyword of the issue article—are provided as a summary of the issue article using the LLM model and the vector database.

The LLM article summarization system further includes a module providing market and economic analysis information on issue articles that affect the global value chain (GVC).
Summarization service for issue articles from overseas media
Web crawling technology for issue articles from overseas media: HTTP-based Open API is used

News article list/articles classified by category from web crawling
Text mining technology: In order to summarize issue articles, a sentence (sentence 2) containing a keyword in areas of interest is selected from the sentences of the issue article by text mining, and sentences (sentences 1, 3 and 4) that do not contain the keyword are deleted
Natural language processing (NLP) large language model (LLM): A summary of an article list/newspaper issue articles classified by category on the basis of titles of English issue articles from overseas media using a BERT or GPT-4 model is provided (English text)
Only sentences containing keywords in areas of interest of the issue article are input to the LLM model through input embedding (text embedding)/position encoding to execute an NLP process.
Perform sentence classification (SC) of English issue articles using a BERT or GPT-4 algorithm used as the LLM model, and distinguish the beginnings and ends of sentences using tokens by a tokenizer [CLS], [September] in BERT.

Marks ends of the sentences (sentences 1, 2, 3, and 4) that make up the issue article </s>

### Ex) BERT Tokenization/Pre-Processing Artifacts

Select sentences containing keywords of issue articles selected by text mining (sentence 2)->text embedding (convert words that make up the selected sentences into numeric vectors)
Extract words that make up the selected sentence (sentence 2)
Generate numeric vectors by word embedding of words that construct noun phrases/adjective phrases/adverb phrases or noun clauses/adjective clauses/adverb clauses of the selected sentence (sentence 2) and a keyword of the issue article, and calculate a relevance between the keyword of the issue article and the words of the phrases/clauses of the selected sentence (sentence 2).
Calculate a similarity by measuring a distance between two vectors using a cosine similarity between a numeric vector of the keyword of the issue article and a numeric vector of words of the selected sentence (sentence 2), and calculate a relevance, which is a similarity greater than a specific value (cosine similarity is a value between −1 and 1, the closer it is to 1, the higher the similarity, and vice versa)
Phrases/clauses included in a sentence are used/deleted as they are based on whether a relevance between words that construct noun clauses/adjective clauses/adverb clauses of the selected sentence (sentence 2) and numeric vectors generated through word embedding of the keyword of the issue article has a similarity greater than/less than a specific value of the keyword
if the similarity is greater than a specific value, then use noun clauses/adjective clauses/adverb clauses as they are
else if the similarity is less than a specific value, then delete noun clauses/adjective clauses/adverb clauses
Generate issue article summary sentences using a keyword combination algorithm
1) Sentence classification (SC): Multiple sentence sets
Sentence classification (SC) that construct an issue article: A sentence set
Preferentially select sentences that contain a keyword of the issue article
Sentences containing the keyword of the issue article by natural language inference (NLI) are selected (positive), that is, sentences containing the keyword of the issue article are selected first, and the remaining sentences that do not contain the keyword of the issue article are deleted (negative).
2) Delete phrases/clauses that construct a long and detailed sentence based on a relevance of a keyword in sentences containing the keyword of the issue article
3) Segmentation of words and keyword combination algorithm: If it is less than a relevance of the keyword of the issue article based on English grammar, sentence structure, and word order, then noun phrases/adjective phrases/adverb phrases or noun clauses/adjective clauses/adverb clauses are deleted
4) Generation of summary sentences of overseas media issue articles

The summarization service system for English issue articles using a web crawler and LLM crawls English issue articles from overseas media, classifies news by article title, stores an article list/articles in a server DB, then sets keywords in areas of interest of the issue article (wars, COVID-19, typhoons, earthquakes, electric vehicle battery explosions, etc.), searches for a keyword of the issue article, performs sentence classification (SC) on the article list/articles, then selects sentences containing the keyword of the issue article through text mining from sentences (sentence 1, 2, 3, 4, etc.) that make up the issue article, and deletes sentences that do not contain the keyword of the issue article by a relevance to the keyword of the issue article through natural language inference (NLI), and
performs text embedding and position encoding on only sentences that contain at least one sentence (sentence 2) selected by the LLM model (BERT or GPT-4) to execute an NLP processing, and the LLM model (BERT or GPT-4) performs sentence classification (SC, multiple sentence sets), then distinguishes the beginnings and the ends of sentences using tokens of at least one selected sentence from a set of selected sentences of the issue article, extracts words from the selected sentence, uses/deletes words included in noun phrases/adjective phrases/adverb phrases or noun clauses/adjective clauses/adverb clauses as they are based on a relevance to the keyword of the issue article, and combines the extracted words from the selected sentences based on a title of the issue article using a keyword combination algorithm according to English grammar, sentence format, and word order to generate a summary of the issue article.

In a news list/article, many English sentences making up an issue article have a subject, a verb, an indirect object/direct object, an adjective, a noun, an adverb, and a complement. The LLM article summarization system uses/deletes the phrases/clauses as they are based on a relevance between a word and a keyword extracted from the selected sentence (sentence 2), the sentences of the issue article including noun clauses, adjective clauses, and adverbial clauses, and uses a keyword combination algorithm that utilizes a segmentation technique of phrases/clauses/words in the selected sentence based on English grammar, sentence format, and word order to generate a summary of the issue article and provide the generated summary to the user terminal.

For example, if an issue article consists of sentences 1, 2, 3, and 4, then a BERT language model is used to perform sentence classification (SC) of the issue article on multiple sentences (sentences 1, 2, 3, and 4) that make up the issue article, then select a sentence (sentence 2) that contains a keyword of the issue article in areas of interest of the issue article, perform text embedding by dividing the beginning and end of the selected sentence into [CLS] and [September], extract words from the selected sentence to execute an LLM model, delete the remaining sentences (sentences 1, 3, and 4) that do not contain a keyword in areas of interest of the issue article, use/delete phrases/clauses that make up the selected sentence by a relevance thereof, and provide a summary of the issue article using a keyword combination algorithm.

Selected sentences making up an issue article have a subject, a verb, an indirect object/direct object, an adjective, a noun, an adverb, and a complement. The type of phrase include a noun phrase, an adjective phrase, and an adverb phrase, and there are a noun clause, an adjective clause, and an adverbial clause. The sentence combination framework is used to summarize the sentences in the extracted issue articles.

For example, the keyword combination algorithm uses a bidirectional encoder representation from transformer (BERT) algorithm or generative pretrained transformer-4 (GPT-4) algorithm as a language model (LM) of natural language processing (NLP) to summarize English issue articles from overseas media. For example, when an issue article consists of sentences 1, 2, 3, and 4, subsequent to performing sentence classification (SC) on the issue article, the algorithm selects a sentence containing a keyword of the issue article (select sentence 2), deletes the remaining sentences that do not contain the keyword of the issue article (delete sentences 1, 3, and 4), then distinguishes between positive and negative sentences based on a relevance of the extracted words and keywords of the selected sentence (sentence 2), uses (an original 1 sentence as it is)/deletes (noun clause/adjective clause/adverb clause—delete), and generates a summary of the issue article using a keyword combination algorithm that utilizes a technique for segmenting words of phrases/clauses in the selected sentences based on English grammar, sentence structure, and word order to display the generated summary on the user terminal.

For reference, Google BERT represents text, which is input data, by integrating bidirectional context based on an encoder of a transformer. In addition, a large corpus including sentences/words of news (issue articles) that do not include labels is pre-trained, and the pre-trained model is fine-tuned by using a database that includes labels of downstream tasks and utilized in various downstream tasks. BERT simply recognizes the form of words or sentences.

A BERT-based natural language processing model receives a large corpus to use a tokenizers library to which the WordPiece tokenization technique is applied.
Text dataset and tokenizers

In an embodiment, when a BERT is used for the LLM model, BERT tokenizers use text embedding and word-based tokenization to construct sentences so as to generate a summary of English issue articles. In an embodiment, BERT tokenizers do not use character-based tokenization.

Large corpus->BERT-> (text data of sentences to be classified)->machine learning model such as LSTM, CNN->classification
Sentence classification (SC): It is a task that returns a probability value of positive, negative, or neutral for a sentence.
Natural Language Inference (NLI): It is used a task that returns a probability value of true, false, or neutral for a sentence.
Named Entity Recognition (NER): It is a task that returns a probability value of a name of entity, such as a name of organization, a name of person, or a name of place.
Question Answering (QA): When a question is given, it is used a task that returns a probability value for an answer (it is a task that returns a probability value of a beginning+an end of a correct answer for each word).
Sentence Generation (SG): It is used a task that receives a sentence and returns a probability value for an entire vocabulary.

Also, a generative pre-trained transformer (GPT) is a natural language processing (NLP) language model (LM), which is available as GPT-3, GPT-3.5, or GPT-4 to summarize issue articles, and provides language translation, text generation, summarization, and question-answering services using artificial intelligence. GPT-4 is a multimodal large-scale language model, which is pre-trained to predict a next token.

The GPT-4 API is a generative AI technology that provides a text summary of token-based sentences in issue articles for a GPT-based large-scale language model (LLM). GPT-4 may reinterpret any kind of text document to generate a summary of issue articles on its own.

For example, for articles on issues affecting the market and economic activities of the global value chain (GVC), such as wars, epidemics, typhoons, earthquakes, and electric vehicle battery explosions, keywords (wars, epidemics, typhoons, earthquakes, and electric vehicle battery explosions) of issue articles from overseas media are set as shown in Table 2, and keyword searches for English issue articles from overseas media may be allowed in a web-based client/server manner.

TABLE 2

| Issue | Date of | | |
|---|---|---|---|
| Article | Occurrence | Keyword | Classification |
| News List/ | Dec. 31, 2019 | COVID Pandemic | Infectious |
| Articles | | outbreak | disease |
| | Feb. 23, 2022 | Russian invasion | War |
| | | of Ukraine | |
| | Aug. 10, 2023 | Electric vehicle | Electric vehicle |
| | | battery explosion | battery |

Table 3 shows items of interest in the issue article-electric vehicle battery.

TABLE 3

| Overseas | | | | | |
|---|---|---|---|---|---|
| media site | Date | Title | Key sentence | Combination | Summary |
| Reuters | Oct. 19, 2023 | Tesla's Musk | The company, which | issue → increase | By the |
| | | raises | built its first | in battery raw | increase in |
| | | Cybertruck | Cybertruck in July, | material prices | battery raw |
| | | production | had in 2019 expected | market play → | material |
| | | concerns, | to price the vehicle | electric vehicle | prices, |
| | | reveals | under $40,000, but | prices | electric |
| | | delivery date | electric vehicle | increase or | vehicle |
| | | | prices have since | decrease in | prices rise |
| | | | risen due to an | the market → | |
| | | | increase in battery | rise | |
| | | | raw material prices. | | |

A summarization service system for English issue articles using a web crawler and LLM crawls English issue articles from overseas media, classifies news by category, stores article lists/articles in a server DB, then performs sentence classification (SC) on issue articles for each article list/article, then selects sentences containing a keyword of issue articles by text mining from sentences (sentences 1, 2, 3, 4, etc.) constructing issue articles, deletes sentences that do not contain the keyword of the issue articles based on a relevance to the keyword of the issue articles by natural language inference (NLI), performs NLP processing by performing text embedding and position encoding only on sentences that contain one or more sentences (sentence 2) selected by an LLM model (BERT or GPT-4), and provides a summary of issue articles from overseas media.

An overseas media issue article summarization service provides a summary of English issue articles, and provides market and economic outlook for issues to companies and customers who need to predict and preemptively respond to risks in the global value chain (GVC) so as to become a very useful solution for economic organizations and companies that need to make decisions.

Embodiments according to the present disclosure may be implemented in the form of program commands that can be executed through various computer elements, and recorded on a computer-readable recording medium. The computer-readable recording medium may include program instructions, data files, data structures, and the like individually or in combination thereof. The computer-readable recording medium may include a hardware device configured to store and execute program instructions on magnetic media such as storages, servers, hard disks, floppy disks and magnetic tapes, optical media such as CD-ROMs and DVDs, magneto-optical media such as floptical disks, and storage media such as ROMs, RAMs, flash memories, storages, and the like. Examples of program instructions may include those produced by a compiler, and high-level language codes that can be executed by a computer using an interpreter, as well as machine codes. The hardware device may be configured to operate as one or more software modules in order to perform the operation of the present disclosure.

The method of the present disclosure may be implemented as a program and stored in a recording medium (CD-ROM, RAM, ROM, memory card, hard disk, magneto-optical disk, storage device, etc.) in a form that can be read using computer software.

As described above, although the present disclosure has been described with reference to specific embodiments, the present disclosure is not limited to the same configuration and operation as the specific embodiments to illustrate the technical concept as described above, and may be implemented by various modifications without departing from the technical concept and scope of the present disclosure, and the scope of the present disclosure should be determined by the claims described below.

What is claimed is:

1. A summarization service system for English issue articles using a web crawler and LLM, the summarization service system comprising:
a web crawler system that crawls English issue articles from overseas media, stores news lists and articles classified by category, and provides a user with a keyword search for issue articles; and
an LLM article summarization system that performs input embedding on only at least one sentence containing a keyword of an issue article selected by text mining into an LLM model, performs text embedding (token embedding) and position encoding by the LLM model to store numeric vectors of the selected sentences of the issue article and position information thereof in a vector database, performs sentence classification (SC) on the selected sentences of the issue article, and then provides a summary of the issue article.

2. The summarization service system of claim 1, further comprising:
a user terminal that collects and crawls English issue articles from overseas media, searches for keywords in issue articles, and displays a summary of issue articles from overseas media,
wherein the user terminal uses a computer, a laptop computer, or a smartphone/tablet PC.

3. The summarization service system of claim 1, wherein the web crawler system comprises:
a web server and a database;
a crawling module that collects and crawls English issue articles of the overseas media to classify news issue articles by category, and stores article lists/articles in a server DB of the web crawler system; and
a keyword search module that searches for English issue articles of the overseas media, and performs a search using keywords in the issue articles.

4. The summarization service system of claim 3, wherein the web crawler system uses a Python crawling program or Selenium automated program provided with a fetcher and a content parser, which are provided with an HTML downloader made with a web crawler, and uses an HTTP-based Open API to browse/download article websites and store them in a content storage.

5. The summarization service system of claim 1, wherein for sentences (sentences 1, 2, 3, 4, . . . ) that make up the issue articles, a sentence (sentence 2) that contains the keyword of the issue article is selected by the text mining, and sentences (sentences 1, 3, and 4) that do not contain the keyword of the issue article are deleted,
wherein only the selected sentence (sentence 2) containing the keyword of the issue article is applied to the LLM model, and words constructing the selected sentence are converted into numeric vectors by text embedding and position encoding to execute an NLP processing of the LLM model, and
wherein the LLM model provides a summary of the issue article using only sentences containing the keyword of the issue article using a BERT model or GPT-4 model.

6. The summarization service system of claim 1, wherein the LLM article summarization system comprises:
an issue article storage module connected to the crawling module to crawl English issue articles of the overseas media, classify the news issue articles by category, and store an article list/articles in a server DB;
a vector database that stores numeric vectors that have passed by text embedding (token embedding)/position encoding on sentences selected from the English issue articles and position information thereof;
a keyword search module that searches for English issue articles of the overseas media, sets a keyword for the English issue articles, and provides a keyword search for the issue articles; and
an issue article summarization module using the LLM that selects sentences containing a keyword of an English issue article from overseas media, deletes the remaining sentences that do not contain the keyword of the issue article, performs sentence classification (SC) on the selected sentences, then classifies the sentences by distinguishing the beginnings and ends of the selected sentences, and generates and provides a summary of the issue article.

7. The summarization service system of claim 6, wherein the issue article summarization module using the LLM performs sentence classification (SC, sentence set) on selected sentences through text embedding with the LLM model, then classifies sentences by distinguishing the beginnings and ends of the selected sentences, calculates a distance and similarity between two vectors by using a cosine similarity between a numeric vector of each word extracted from the selected sentence and a numeric vector of the keyword of the issue article, calculates a relevance, which is a similarity greater than a specific value, uses phrases/paragraphs as they are in the selected sentence (sentence 2) higher than a relevance having a similarity greater than a specific value between the keyword of the issue article and words that construct the selected sentence, deletes phrases/paragraphs less than the relevance, generates and stores a summary of the issue article using a keyword combination algorithm of words that construct the selected sentence in accordance with English grammar, sentence format, and word order, and provides a summary of the issue article to the user terminal.

8. The summarization service system of claim 6, wherein the LLM article summarization system further comprises a module providing market and economic analysis information on issue articles that affect the global value chain (GVC).
